(19) United States
(12) Patent Application Publication
(10) Pub. No.: US 2018/0010221 A1
(43) Pub. Date: Jan. 11, 2018

(54) ADDITIVE MANUFACTURING METHOD AND POWDER

(71) Applicant: RENISHAW PLC, Wotton-under-Edge (GB)

(72) Inventors: Ravi Guttamindapalli ASWATHANARAYANASWAMY, Stone (GB); Hossein SHEYKH-POOR, Manchester (GB); Peter George Eveleigh JERRARD, Stoke-on-Trent (GB)

(73) Assignee: RENISHAW PLC, Wotton-under-Edge, Gloucestershire (GB)

(21) Appl. No.: 15/506,007

(22) PCT Filed: Sep. 10, 2015
(86) PCT No.: PCT/GB2015/052611

§ 371 Date: Feb. 23, 2017

(30) Foreign Application Priority Data
Sep. 10, 2014 (GB) 1415953.7

(51) Int. Cl. C22C 38/44; C22C 38/02; B23K 26/342; B23K 26/144; C22C 38/42; B22F 9/08; C22C 38/04; C22C 38/00

(52) U.S. Cl. CPC C22C 38/44; B33Y 70/00; C22C 38/04; C22C 38/02; C22C 38/002; B23K 26/144; B33Y 10/00; C22C 38/42; B22F 9/082; B23K 26/342; C22C 38/001; B22F 2009/0824; B22F 2009/0848

(57) ABSTRACT

A method of manufacturing a part including selective laser melting of a powder including a steel alloy containing, by weight, 16% to 19% chromium and 12.2% to 13.5% nickel, wherein the powder is substantially non-magnetic.

### FIELD OF INVENTION

This invention concerns an additive manufacturing method and powder to be used in such a method. The invention has particular applicability to a method of selective laser melting (SLM) steel powders.

### BACKGROUND

Selective laser melting (SLM) is a rapid prototyping (RP) and/or rapid manufacturing (RM) technology which may be used for the production of metallic solid and porous articles. Conveniently, the articles may have suitable properties to be put straight in to use. For instance, SLM may be used to produce one-off articles such as parts or components which are bespoke to their intended application. Similarly, SLM may be used to produce large or small batches of articles such as parts or components for a specific application.

SLM builds articles in a layer-by-layer fashion. Typically, this requires thin (e.g. from 20 μm to 100 μm) uniform layers of fine metal powders to be deposited on a substrate. For example, the powder layers may be formed by spreading powders across the substrate using a wiper blade or roller. After formation of a powder layer, the powder particles are fused together by scanning selected areas of the powder layer with a laser, usually according to a model's 3D CAD data. To form the next layer, the substrate is lowered and the process repeated.

SLM relies on converting the selected areas of a powder layer into a melt pool throughout the layer thickness (a so called “fully melted layer”) such that the solid weld bead fuses to underlying solidified material. It is desirable to form a part with close to 100% theoretical density (a “fully dense part”). Whether fully dense layers are achieved for a set of laser parameters will depend on material properties of the powder. Two material properties that affect the melt properties of the powder layer are powder composition and flow characteristics. The composition of the powder and flow of the powder affects how the powder particles absorb energy from the laser beam. More specifically, the flow characteristics affect the packing density of the powder when formed into a layer, the packing density in turn affecting the formation of the melt pool. Insufficient absorption of energy from the laser will result in the layer not being melted throughout its layer thickness. Over-heating of the layer will cause vaporisation of the melted powder potentially resulting in the formation of voids in the solidified layer. In both cases, this may result in a less than fully dense part.

Marine grade steels, such as stainless steel 316L, are desirable materials to use in additive manufacturing because of the wide array of applications.

### SUMMARY OF INVENTION

According to a first aspect of the invention there is provided a method of manufacturing a part comprising selective laser melting of a powder comprising a steel alloy containing, by weight, 16% to 19% chromium and 12.2% to 13.5% nickel, wherein the powder is substantially non-magnetic.

Parts have been manufactured using this method with a density of greater than 99.5% theoretical density. It has been found that parts manufactured having a nickel content at the outer bounds of the 10% to 14% ASTM standard for 316 stainless steels do not produce parts having a density of greater than 99.5% theoretical density. Furthermore, it has been found that the magnetic properties of the powder have a significant effect on the flow characteristics of the powder. Powder that exhibits significant movement in response to a magnet tends to flow poorly, which can lead to poor build quality in selective laser melting.

A percentage by volume of ferrite phase present in the steel alloy affects the magnetic properties of the powder. In one embodiment, less than 2% by volume of the steel alloy is in the ferrite phase. Preferably, less than 1.5%, more preferably less than 1%, even more preferably less than 0.5% by volume and most preferably, substantially 0% by volume of the steel alloy is in the ferrite phase. Such powder may be sufficiently non-magnetic such that the required flow and therefore, melt characteristics are achieved. The powder may have a hall flow of less than 23 s, preferably less than 22 s and most preferably, less than 21 s

The alloy may contain by weight more than 12.2% nickel and more preferably more than 12.5% nickel. The alloy may contain by weight less than 13.2% nickel and more preferably, less than 12.7% nickel. The alloy may contain, by weight, 12.2% to 13.2% nickel, 12.5% to 12.9% nickel and most preferably, 12.7% nickel.

The alloy may contain by weight more than 16% chromium, more preferably more than 16.5% chromium and most preferably more than 16.8% chromium. The alloy may contain by weight less than 18% chromium, more preferably less than 17.5% chromium and most preferably, less than 17.2% chromium. The alloy may contain, by weight, 16% to 18% chromium, 16.5% to 17.5% chromium, 16.8% to 17.2% chromium and most preferably, 17% chromium.

The alloy may contain, by weight, less than 1% manganese, preferably, less than 0.7% manganese and most preferably, less than 0.5% manganese. The alloy may contain, by weight, less than 0.01% sulphur. Manganese and sulphur are elements with low vapour pressure and, therefore, easily form metallic fumes during melting with the laser beam. The fumes may agglomerate on the solidified surfaces of the layers, forming undesirable non-metallic inclusions in the form of manganese sulphide within the part.

The alloy may also contain molybdenum, preferably, 2% to 3% by weight, silicon, preferably, less than 1% by weight, carbon, preferably, less than 0.1% by weight, and phosphorus, preferably less than 0.2% by weight. Other elements that may be included in the powder alloy are one or more selected from the group of copper, preferably, 0.05% to 0.5% by weight, niobium, preferably 0.05% to 1% by weight, nitrogen, preferably 0.05% to 0.3% by weight and titanium, 0.05% to 0.1% by weight.

The balance, disregarding trace elements (<0.05% by weight), may be iron.

The alloy may comprise austenite as its primary phase. At least 98%, preferably at least 98.5%, more preferably, at least 99%, even more preferably at least 99.5% and most preferably, substantially 100% by volume of the alloy may be in the austenite phase. The austenite phase is non-magnetic, a desirable property in order to achieve good flow.

The powder may have been formed by nitrogen gas atomisation. Nitrogen may aid in the formation of the austenite phase during atomisation.

The powder may be atomised from an ingot produced by vacuum arc remelting (VAR). Vacuum arc remelting may reduce the presence of oxygen in the ingot and therefore, in the powder produced through atomisation.

The powder may contain at least 90% by weight, preferably at least 94% by weight and most preferably, at least 96% weight particles having a size, as measured by a laser diffraction particle size analyser, below 45 μm. The powder may contain less than 2% by weight and preferably, less than 1% by weight of particles having a size below 15 μm. The powder may contain less than 3% by weight and preferably, less than 2% by weight of particles having a size above 45 μm. It is believed that this particle size distribution provides suitable flow characteristics.

According to a second aspect of the invention there is provided a powder container arranged to be attached to an additive manufacturing machine, the powder container containing powder comprising a steel alloy containing, by weight, 16% to 19% chromium and 12.2% to 13.5% nickel, wherein the powder is substantially non-magnetic.

According to a third aspect of the invention there is provided a method of manufacturing powder for use in additive manufacturing apparatus comprising atomising a molten steel alloy containing, by weight, 16% to 19% chromium and 12.2% to 13.5% nickel such that less than 2% by volume of the steel alloy is in the ferrite phase and filling a container arranged to be attached to an additive manufacturing machine with the powder.

The method may comprise nitrogen atomising the molten steel alloy. Nitrogen may aid in the formation of the austenite phase during atomisation.

### DESCRIPTION OF THE DRAWINGS

FIG. 1 illustrates a typical SLM and apparatus;

FIG. 2 illustrates laser scanning parameters;

FIG. 3 is an optical image of a SLM manufactured part produced from 316L powder comprising 10.7% nickel by weight with a first set of process parameters;

FIG. 4 is an optical image of a SLM manufactured part produced from the same 316L powder as the part shown in FIG. 3 but with a second set of process parameters;

FIG. 5 is an optical image of a SLM manufactured part produced from 316L powder comprising 10.8% nickel by weight;

FIG. 6 is an optical image of a SLM manufactured part produced from 316L powder comprising 12.7% nickel by weight;

FIGS. 7a to 7e shows particles of different 316L powders etched using 10% oxalic acid for 30 seconds;

FIGS. 8a and 8b are images of locations on powder samples used to generate Energy Dispersive X-ray spectra;

FIGS. 9a and 9b are graphs showing Energy Dispersive X-Ray spectroscopy results from the locations shown in FIGS. 8a and 8b;

FIGS. 10a and 10b are images showing the movement of powder produced by a magnet; and

FIG. 11 is a graph showing density of material achieved for different energy densities of a laser beam.

### DESCRIPTION OF EMBODIMENTS

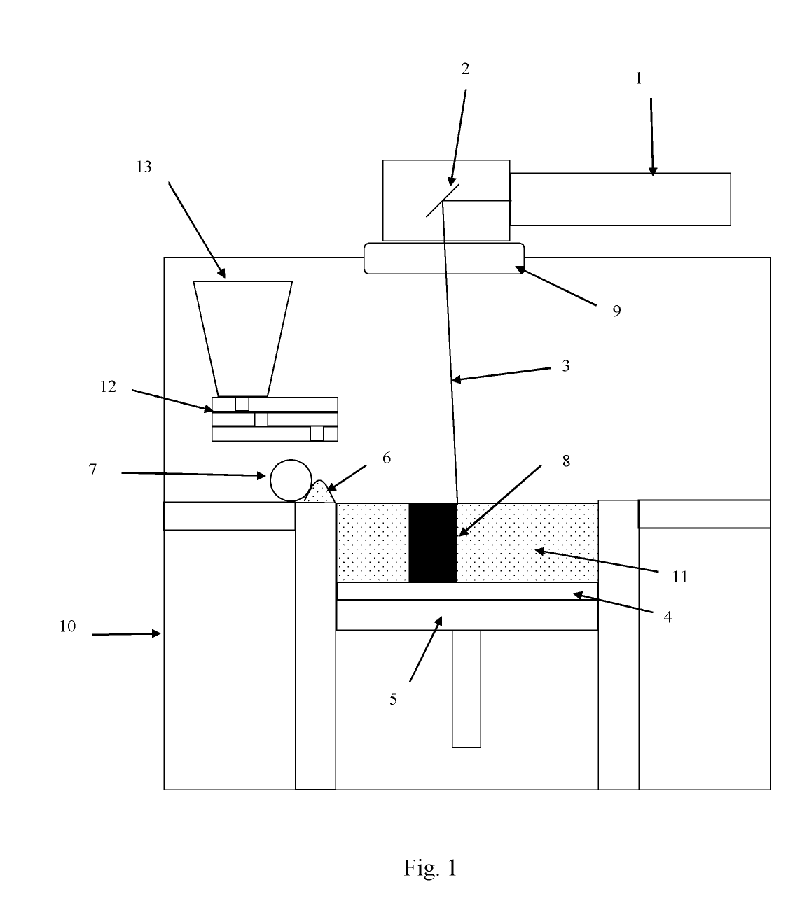

FIG. 1 schematically shows the SLM process and apparatus. The apparatus comprises a laser 1, in this embodiment an ytterbium fibre laser, which emits a laser beam 3. One or more scanning mirrors 2 serve to direct the laser beam 3 through a window 9 in a build chamber 10 on to the powder 11. The powder 11 is provided on a build substrate 4 which can be moved up and down by operation of a piston 5. A powder deposition or recoating mechanism for depositing the powder in layers during the SLM process comprises a roller/wiper blade 7. A dose of powder 6 is dispensed from hopper 13 in front of the roller/wiper blade 7 by dispensing mechanism 12, which may be in accordance with the mechanism described in WO2010/007396.

In use, powder layers are uniformly spread on a substrate provided on the base plate 4 using the powder deposition mechanism 7. Each layer is scanned with the ytterbium fibre laser beam 3 (wavelength (λ)=1.06 μm, beam spot diameter=75+/−5 μm) according to CAD data. The melt powder particles fuse together (a solidified portion is indicated at 8), forming a layer of the article or part, and the process is repeated until the top layer. The article or part is then removed from the substrate and any unfused powder can be reused for the next build. The process is performed under an inert environment, which is normally argon, while the oxygen level is typically 0.1-0.2 volume %. During the SLM process, the chamber atmosphere, which is kept at an overpressure of 10-12 mbar, is continuously recirculated and filtered.

The input data for making a part comprise geometrical data stored as a CAD file and the laser scanning process parameters. The main process parameters which may affect the density of aluminium SLM parts include: laser power; the laser scanning speed which depends on the exposure time on each of the laser spots that constitute the scanned path, and the distance between them (point distance); and the distance between the laser hatches.

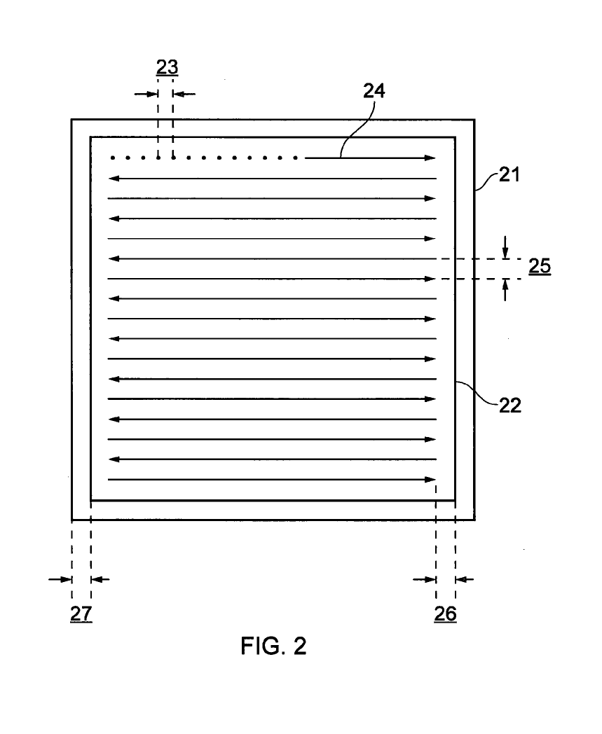

FIG. 2 illustrates some of the main laser scanning parameters. The arrows indicate a laser scanning pattern across a sample. FIG. 2 shows a boundary 21, inside which there is a fill contour 22. A fill contour offset 27 constitutes the distance between the boundary 21 and the fill contour 22. The laser scanning pattern covers substantially all of the sample within the fill contour 22. The laser scanning pattern constitutes a path (indicated by the arrows) made up of a series of laser spots. For illustrative purposes a few of these laser spots are shown individually in the top line of the laser scanning pattern. The distance from a given laser spot to the next laser spot in the sequence is known as the point distance 23. Each line within the laser scanning pattern is known as a hatch 24. The laser scanning pattern illustrated in FIG. 2 comprises 17 substantially parallel hatches; the laser scans in a first direction along a first hatch, then in a second opposite direction along a second hatch, then in the first direction along a third hatch, then in the second opposite direction along a fourth hatch and so on. The distance from an end of a hatch 24 to the fill contour 22 is known as the hatch offset 26. The distance between one hatch and the next hatch in the sequence, e.g. between a sixth hatch and a seventh hatch, is known as the hatch distance 25.

### Example 1

316L stainless steel powder in the range 15 to 45 μm was supplied by Sandvik Osprey Ltd, with a dispatch number 14D0097. The powder batch was 10 kg in weight and contained a test certificate. Details from the test certificate are shown in table 1

TABLE 1

| | | | Powder |
|---|---|---|---|
| | | Powder Size Distribution | Tests |
| Element | Wt (%) | (μm) | (μm) |
| Cr | 17.1 | +45 = 1.0% | d10 = 19.8 |
| Ni | 10.8 | | |
| Mo | 2.6 | −45 to +15 = 97.9% | d50 = 31.3 |
| Mn | 1.07 | | |
| C | 0.02 | −15 = 1.1% | d90 = 49.9 |
| P | 0.02 | | |
| S | 0.01 | | |
| Fe | Balance | | |

The composition of the powder was checked by chemical analysis using energy dispersive X-ray spectroscopy (EDS). EDS was carried out on three different powder particles. The results are shown in table 2.

TABLE 2

| Elements (wt %) | Fe | Si | Cr | Ni | Mo |
|---|---|---|---|---|---|
| 1 | 67.52 | 0.66 | 18.29 | 10.24 | 3.29 |
| 2 | 66.97 | 0.57 | 18.25 | 11.04 | 3.18 |
| 3 | 67.72 | 0.67 | 18.04 | 10.83 | 2.75 |
| Average | 67.40 | 0.63 | 18.19 | 10.70 | 3.07 |

A hall flow for the powder was measured to be 20.1 sec/50 g.

A set of 34 samples were manufactured in a Renishaw AM250 selective laser melting machine using the 316L powder. The laser process parameters were varied, with two samples built for each laser parameter set listed in table 3.

TABLE 3

| Process | | POINT | EXPOSURE | HATCH | |
|---|---|---|---|---|---|
| Param- | POWER | DISTANCE | TIME | SPACE | ENERGY |
| eter | (P) | (PD) | (Exp) | (HS) | DENSITY |
| Set | W | μm | μSec | μm | (J/mm²) |
| 1 | 200 | 110 | 60 | 50 | 2.18 |
| 2 | 100 | 50 | 120 | 50 | 4.80 |
| 3 | 100 | 110 | 120 | 50 | 2.18 |
| 4 | 100 | 50 | 60 | 110 | 1.09 |
| 5 | 100 | 110 | 60 | 50 | 1.09 |
| 6 | 200 | 110 | 120 | 50 | 4.36 |
| 7 | 100 | 50 | 120 | 110 | 2.18 |
| 8 | 200 | 50 | 60 | 110 | 2.18 |
| 9 | 200 | 110 | 60 | 110 | 0.99 |
| 10 | 100 | 50 | 60 | 50 | 2.40 |
| 11 | 200 | 50 | 120 | 50 | 9.60 |
| 12 | 100 | 110 | 60 | 110 | 0.50 |
| 13 | 100 | 110 | 120 | 110 | 0.99 |
| 14 | 200 | 110 | 120 | 110 | 1.98 |
| 15 | 200 | 50 | 60 | 50 | 4.80 |
| 16 | 150 | 80 | 90 | 80 | 2.11 |
| 17 | 200 | 50 | 120 | 110 | 4.36 |

At the end of the laser melting process, the samples were removed from the build chamber and the build substrate and mounted in a 30 mm diameter mould using Buehler cold mount material. The samples were polished to a 50 nm finish and then analysed using an OPG Smartscope QVI instrument.

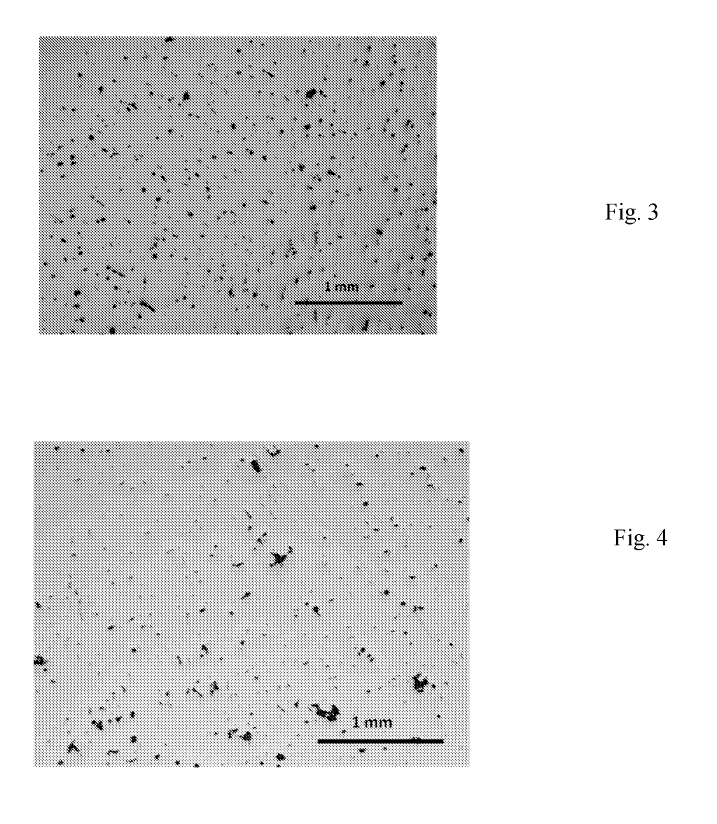

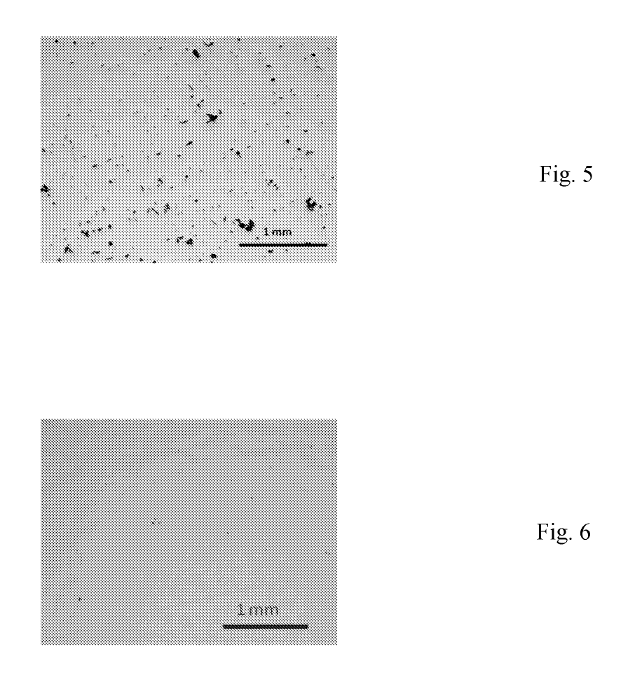

From this analysis it was observed that the process parameters used did not produce any samples above the 99.5% threshold at which a part is considered to be acceptably dense. FIGS. 3 and 4 show the maximum density that was achieved, in both cases below the 99.5% threshold.

### Example 2

316L stainless steel powder supplied by Sandvik Osprey Ltd. was compared to two batches of 316L stainless steel powder supplied by LPW Technology Ltd (LPW 1 and LPW 2). The composition, particle size and Hall flow was determined for each powder. Tables 4 to 6 show the results.

TABLE 4

| | Composition (wt %) | | | | | | | | |
|---|---|---|---|---|---|---|---|---|---|
| Sample | Fe | Cr | Ni | Mo | Mn | Si | C | P | S |
| LPW A | Balance | 17.0 | 11.9 | 2.28 | 1.4 | 0.6 | 0.018 | 0.01 | 0.008 |
| LPW B | Balance | 17.4 | 12.2 | 2.29 | 1.42 | 0.65 | 0.02 | 0.012 | 0.009 |
| Osprey | Balance | 17.1 | 10.8 | 2.57 | 1.07 | 0.53 | 0.02 | 0.016 | 0.006 |
| 14D0097 | | | | | | | | | |

TABLE 5

| | Particle Size (μm) | | |
|---|---|---|---|
| Sample | d10 | d50 | d90 |
| LPW A | 18.4 | 27.41 | 42.37 |
| LPW B | 17.17 | 25.45 | 39.23 |
| Osprey 14D0097 | 19.81 | 31.28 | 49.86 |

TABLE 6

| Sample | Hall Flow (s) |
|---|---|
| LPW A | 24 |
| LPW B | 28 |
| Osprey 14D0097 | 20.1 |

As can be seen the flow characteristics of the Sandvik 316L powder is superior to the flow characteristics of the LPW 316L powders, despite generally similar particle size distributions.

### Example 3

A comparison was made between two different 316L stainless steel powders. Tables 7 and 8 show the composition and particle size data for each powder.

TABLE 7
Powder 1

| Element | Actual (wt %) | Particle Size Data |
|---|---|---|
| Cr | 17.1 | >45 μm = 1.0% |
| Ni | 10.8 | |
| Mo | 2.6 | |
| Mn | 1.07 | Between |
| Si | 0.63 | 45 μm to 15 |
| C | 0.02 | μm = 97.9% |
| P | 0.02 | <15 μm = 1.1% |
| S | 0.01 | |
| Fe | BALANCE | |

TABLE 8
Powder 2

| Element | Actual (wt %) | Particle Size Data |
|---|---|---|
| Cr | 17.1 | >45 μm = 2.0% |
| Ni | 12.7 | |
| Mo | 2.3 | |
| Mn | 0.45 | Between |
| Si | 0.38 | 45 μm to 15 |
| C | 0.02 | μm = 98.0% |
| P | 0.01 | <15 μm = 0.0% |
| S | 0.01 | |
| Fe | BALANCE | |

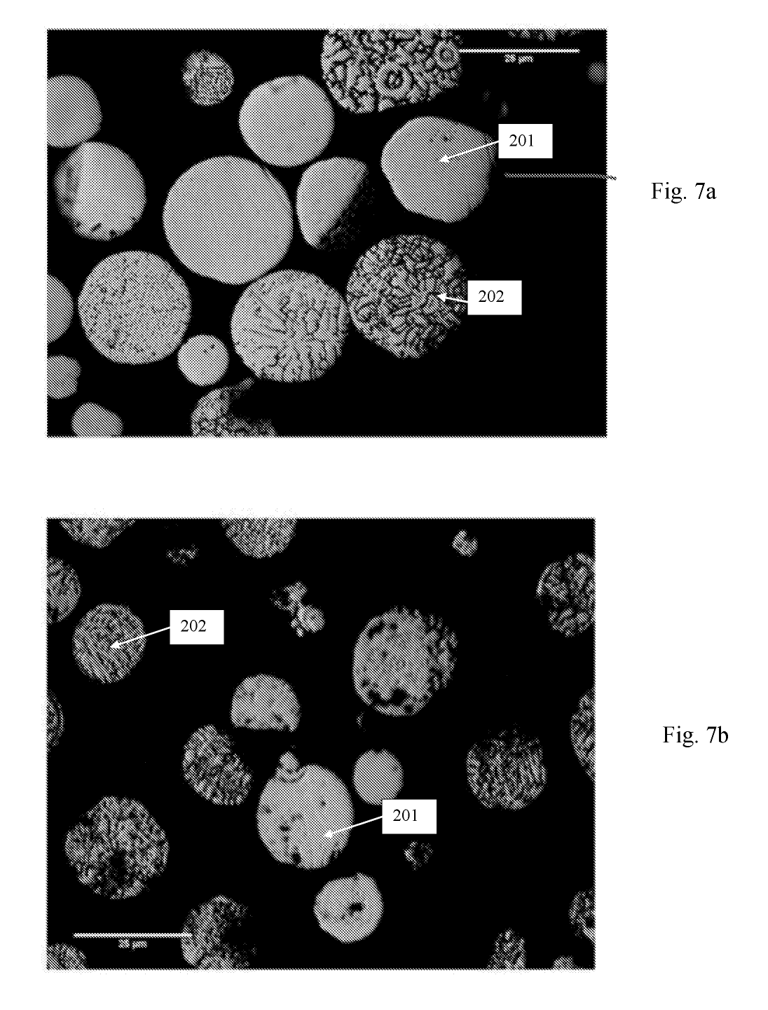

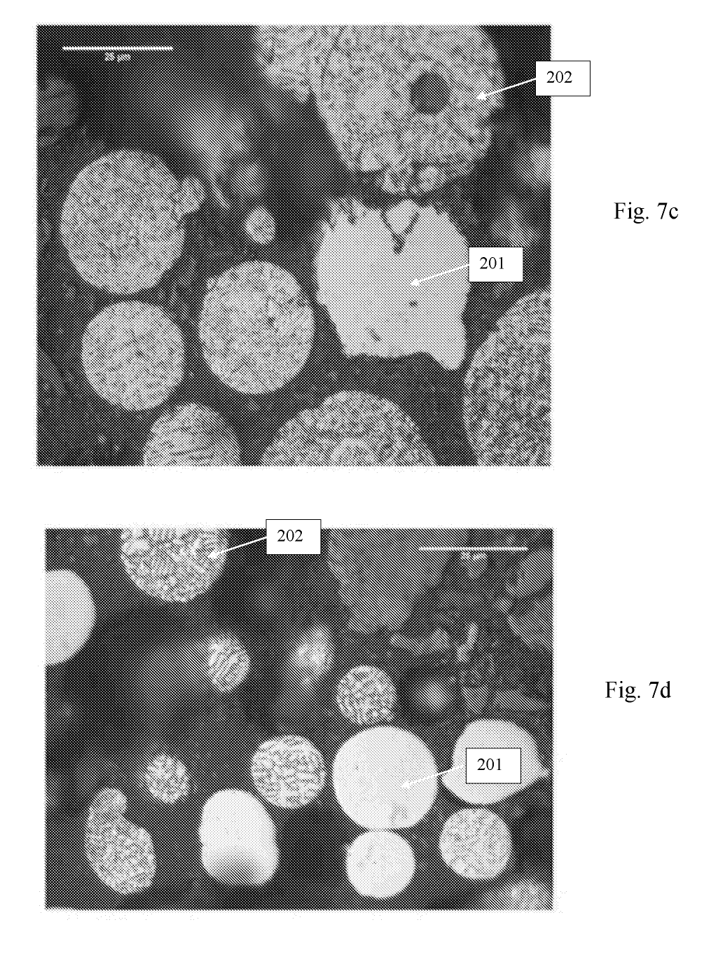

The main changes between powder 1 and powder 2 was an increase in nickel content and a reduction in manganese content. Hall flow tests were carried out on the two powders and Powder 1 was measured to have a Hall flow of 20.13 sec/50 g and Powder 2 was measured to have a Hall flow of 20.5 sec/50 g. Samples were built in a Renishaw AM250 selective laser melting machine using the Powder 1 and Powder 2. The laser process parameters were varied in accordance with the parameter sets listed in table 3. Tables 9 and 10 show the parameters sets that achieved the best densities for Powder 1 and Powder 2. As can be seen, the best density that was achieved for Powder 1 is 98.5% whereas a density greater than 99.5% is achieved for Powder 2. FIGS. 5 and 6 are images taken using an OPG Smartscope QVI instrument, in which the different densities can be visually identified.

TABLE 9

| Powder 1 | | | | | |
|---|---|---|---|---|---|
| | | | | Density | Target |
| P | P D | Exp | H S | Achieved | Density |
| (W) | (μm) | (μm) | (μm) | (%) | (%) |
| 200 | 110 | 120 | 110 | 98.5 | ≧99.5 |

TABLE 10

| Powder 2 | | | | | |
|---|---|---|---|---|---|
| | | | | Density | Target |
| P | P D | Exp | H S | Achieved | Density |
| (W) | (μm) | (μm) | (μm) | (%) | (%) |
| 200 | 40 | 90 | 100 | 99.94 | ≧99.5 |
| 200 | 50 | 110 | 100 | 99.91 | ≧99.5 |

### Example 4

Four 316L powders supplied by LPW Technologies Ltd (LPW) were compared to a 316L powder supplied by Sandvik Osprey Ltd. (SO). Table 11 shows the chemical composition of each powder. Nitrogen, oxygen and copper were not reported for 316L-SV.

TABLE 11

| | 316L-1 | 316L-6 | 316L-7 | 316L-8 | 316L-SV |
|---|---|---|---|---|---|
| Elements | (LPW) | (LPW) | (LPW) | (LPW) | (SO) |
| Fe | 64.813 | 63.366 | 68.107 | 64.7355 | 68.28 |
| Cr | 17.9 | 18.10 | 16.94 | 17.8 | 16.8 |
| Ni | 12.6 | 14.08 | 12.24 | 12.6 | 10.7 |
| Mo | 2.34 | 2.85 | 2.39 | 2.33 | 2.2 |
| Mn | 1.4 | 1.01 | 1.03 | 1.47 | 1.35 |
| Si | 0.59 | 0.49 | 0.46 | 0.66 | 0.62 |
| P | 0.017 | 0.025 | 0.005 | 0.021 | 0.023 |
| S | 0.005 | 0.01 | 0.01 | 0.005 | 0.01 |
| C | 0.02 | 0.01 | 0.008 | 0.026 | 0.017 |
| N | 0.1 | 0.02 | 0 | 0.1 | N/R |
| O | 0.025 | 0.029 | 0.04 | 0.0125 | N/R |
| Cu | 0.19 | 0.01 | 0.01 | 0.24 | N/R |

The powders were placed in a dish and a magnet brought into close proximity to the powder. The observation showed that 316L-7 responded most strongly to the magnet, forming a hair like structure, as one would expect to see for a ferritic powder. 316L-1 and 316L-8 showed significant deformation when brought into proximity with the magnet and 316L-6 moved with the movement of the magnet. 316L-SV responded weakly to the magnet, with very slight variation in the appearance of the powder.

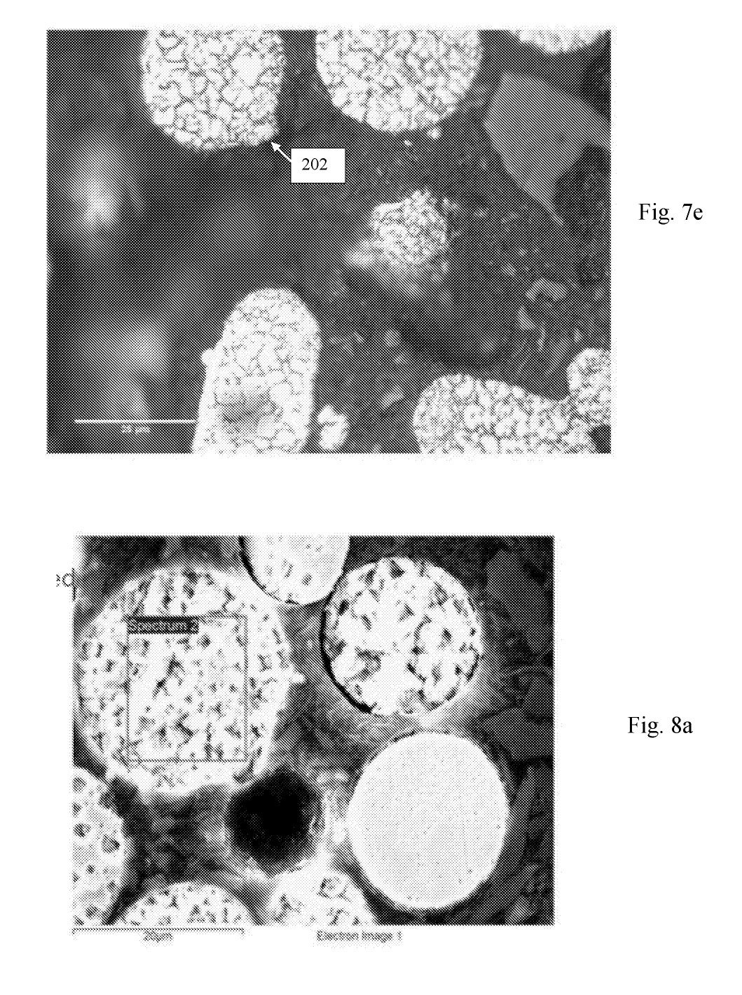

A sample of each powder was etched using 10% Oxalic acid for 30 seconds. The etched sample was mounted on a conductive resin under an optical microscope. FIGS. 7a to 7d are images of the samples of powders 316L-1, 316L-6, 316L-7 and 316L-8, respectively. As can be seen, some of the particles, examples of which are identified by 202, have been etched to reveal the grain structure whereas other particles, examples of which are identified by 201, have failed to etch. Oxalic acid does not react with ferritic steel and the failure to etch some of the particles indicates that these particles are ferritic in structure.

FIG. 7e is an image of the sample of 316L-SV after etching. In the image all particles have been etched successfully indicating that the majority of the particles are austenitic.

The samples were then colour etched. The particles that failed to etch using the oxalic acid also failed to etch using the colour etching. This provides further indication that the particles that failed to etch have a different crystalline structure to those that did etch.

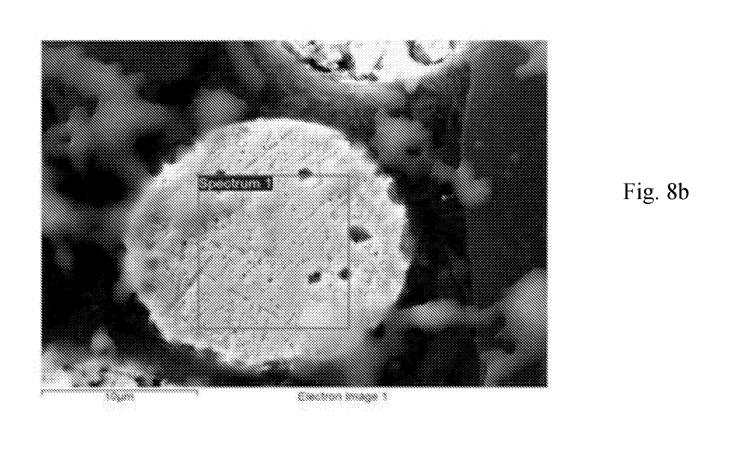

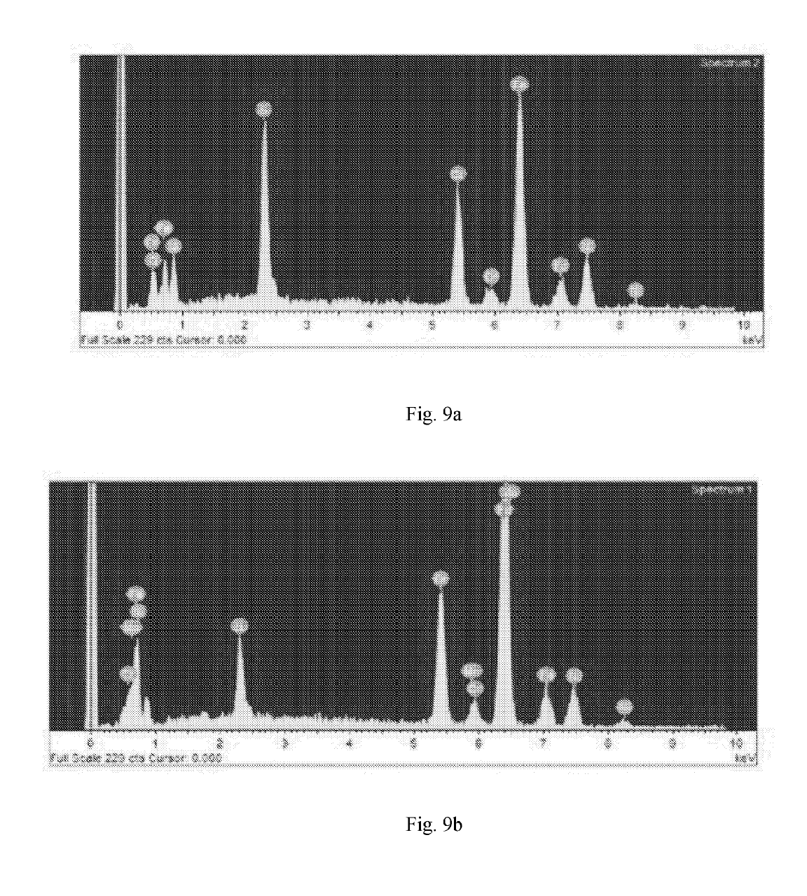

X-Ray spectroscopy was carried out on particles of the sample for 316L-6 that did and did not etch to determine if there was any difference in the composition of the particles. FIGS. 8a and 8b show the locations on the samples at which X-ray spectroscopy was carried out. FIGS. 9a and 9b show the X-ray spectra obtained from these locations. These spectra show that the particles that failed to etch have the same composition as the particles that successfully etched. Accordingly, the particles that failed to etch are not contaminants.

The above tests indicate that, with the exception of 316L-SV, a significant proportion of the powders are not austenitic in structure. It is worth noting that FIG. 9a shows a Niα peak which is significantly higher than the Feβ peak, whilst FIG. 9b shows the two peaks are about the same. This suggests that the particles that failed to etch have a lower ratio of nickel to iron compared to the particles that did etch. Nickel is an austenite stabiliser for stainless steel.

### Example 5

XRD pattern analysis was carried out on the powders to determine a percentage by volume of the austenite phase and ferrite phase in the powders. The results are shown in table 12.

TABLE 12

| | Austenite Volume | Ferrite Volume |
|---|---|---|
| Powder | Fraction (%) | Fraction (%) |
| 316L - 1 | 96.2 | 3.8 |
| 316L - 6 | 96.0 | 4.0 |
| 316L - 7 | 93.8 | 6.2 |
| 316L - 8 | 97.6 | 2.4 |
| 316L - Phase 1 | 100 | 0.0 (or below instrument |
| | | detectable limit 0.5 wt %) |

### Example 6

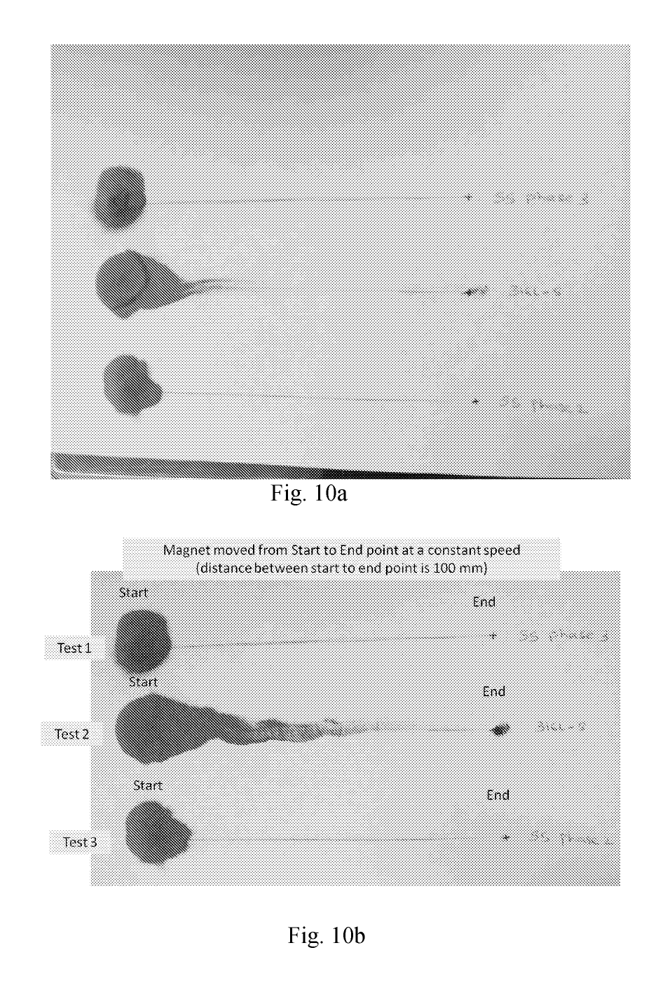

Tests were performed on the Sandvik 316L powders, phase 2 and phase 3, and 316L-8 powder supplied by LPW using a magnet. A sheet of paper was mounted to a plastic lid by pins and 100 mm lines drawn from a start point to an end point. 1+/−0.05 grams of each powder was deposited at the start point of each line using a Carney funnel centred at the start point. A N42 grade, NiCuNi plated magnet supplied by eMagents, UK having a 15 mm diameter, 4 mm thickness and a pull of 3.3 kg was placed beneath the plastic lid at the start point. In a first experiment the magnet was moved by hand at a constant speed in a straight line from the start point to the end point. FIG. 10a illustrates the powder pattern generated by this movement for each powder. The upper pattern corresponds to phase 3 of the Sandvik powder, the centre pattern corresponds to 316L-8 and the lower pattern corresponds to phase 2 of the Sandvik powder. In a second experiment the magnet was moved in a spiral motion at a constant speed progressing from the start point to the end point. FIG. 10b illustrates the powder pattern generated by this movement for each powder. The upper pattern corresponds to phase 3 of the Sandvik powder, the centre pattern corresponds to 316L-8 and the lower pattern corresponds to phase 2 of the Sandvik powder. As can be seen, the 316L-8 powder reacts more strongly to movement of the magnet than the Sandvik powder.

### Example 7

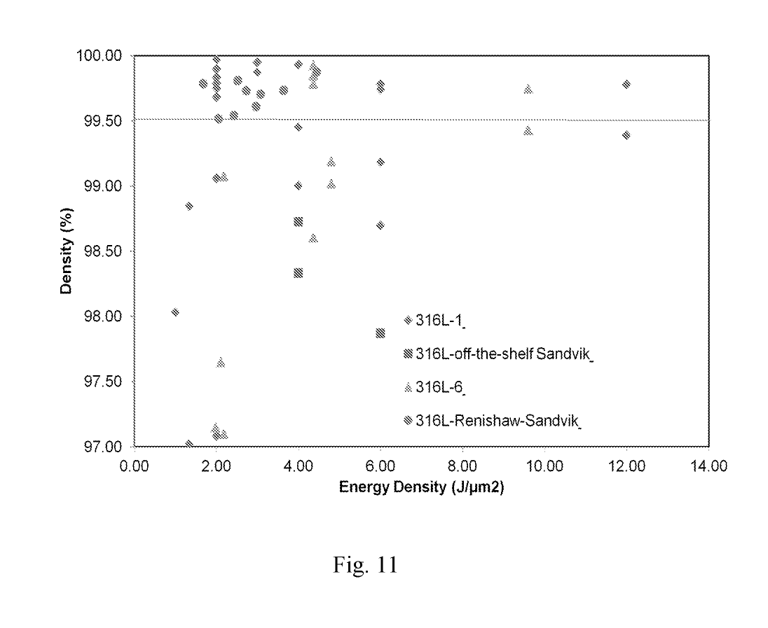

FIG. 11 is a graph showing the density achieved for different materials for different laser beam energy densities. The compositions of the powders are given in tables 13 to 16.

TABLE 13
316L-1

| | Weight Percentage |
|---|---|
| Elements | (wt %) |
| Fe | Balance |
| C | 0.020 |
| Si | 0.59 |
| Mn | 1.40 |
| P | 0.017 |
| S | 0.005 |
| Cr | 17.9 |
| Ni | 12.6 |
| Mo | 2.34 |
| N | 0.1 |
| Cu | 0.19 |
| O | 0.025 |

TABLE 14
316L-6

| | Weight Percentage |
|---|---|
| Elements | (wt %) |
| Fe | Balance |
| C | <0.01 |
| Si | 0.49 |
| Mn | 1.01 |
| P | 0.01 |
| S | <0.01 |
| Cr | 18.1 |
| Ni | 14.1 |
| Mo | 2.85 |
| N | 0.02 |
| Cu | 0.01 |
| O | 0.03 |

TABLE 15
316L - Off the shelf Sandvik

| | Weight Percentage |
|---|---|
| Elements | (wt %) |
| Fe | Balance |
| C | 0.02 |
| Si | 0.6 |
| Mn | 1.1 |
| P | 0.02 |
| S | 0.01 |
| Cr | 17.1 |
| Ni | 10.8 |
| Mo | 2.6 |
| N | 0.17 |
| O | 0.04 |

TABLE 16
316L - Renishaw Sandvik

| | Weight Percentage |
|---|---|
| Elements | (wt %) |
| Fe | Balance |
| C | 0.02 |
| Si | 0.4 |
| Mn | 0.5 |
| P | 0.01 |
| S | 0.01 |
| Cr | 17.1 |
| Ni | 12.7 |
| Mo | 2.3 |
| N | 0.09 |
| O | 0.05 |

As can be seen from FIG. 11, then energy density required to produce parts having higher than 99.5% density from the 316L-6 powder is higher than that required to produce parts of similar density using the 316L Renishaw-Sandvik powder. It was not possible to produce a part having a density higher than 99.5% with the 316L-off-the-shelf Sandvik powder. At energy densities of between 2.2 to 2.5 J/μm² surface burning effects start to become apparent. Such surface burning effects can result in discoloration of the surface of the part, overmelting and consequential warping of the part, especially for thin geometries, and a higher hardness causing the part to become brittle. These surface burning effects become more apparent at higher energy densities.

In conclusion, the powders supplied by LPW Technologies Ltd have been found to be more magnetic than the powders supplied by Sandvik Osprey Ltd. There is evidence to suggest that this is because of a larger number of ferritic particles in the LPW powder compared to the Sandvik powder. The poorer flow characteristics of the LPW powder may be due to the stronger magnetic properties of this powder.

Furthermore, the Sandvik powder fails to produce a fully dense part under parameter sets that can be selected in the Renishaw 250AM machine. It has been found that a powder in which the nickel content has been increased and the manganese content reduced can produce a fully dense part.

A suitable powder 316L composition for additive manufacturing that has suitable flow characteristics and can be used to produce a fully dense part (greater than 99.5% theoretical density) is:

TABLE 17

| Element | wt % |
|---|---|
| Cr | 17 ± 0.2 |
| Ni | 12.5 ± 0.2 |
| Mo | 2.3 ± 0.2 |
| Mn | 0.45 ± 0.2 |
| Si | 0.4 ± 0.1 |
| Cu | 0.2 ± 0.2 |
| C | 0.02 |
| P | 0.01 |
| S | 0.01 |
| Fe | BALANCE |

with less than 0.5% by volume of the alloy in the ferritic phase and a particle size distribution, wherein d10=20 to 27 μm, d50=32 to 39 μm and d90=50 to 55 μm. The powder may be manufactured by nitrogen atomisation of the molten steel alloy. An amount of oxygen in the melt chamber and the atomising chamber may be reduced to less than 500 parts per million.

In a further embodiment, a small proportion of oxygen may be introduced into the atomising stream. For example, the atomising stream may be about 99.4% nitrogen and about 0.5% oxygen. Containers arranged to be connected to an additive manufacturing machine may be filled with the powder.

Modifications and variations to the above described embodiment may be made without departing from the invention as defined herein. For example, a powder composition having a nickel and/or manganese content outside of the ranges specified in table 12 may still be used to produce a fully dense part. The alloy, before being melted for atomisation, may be subjected to a vacuum arc remelting process to reduce the amount of oxygen present in the atomised steel.

Other non-trace elements, such as niobium, nitrogen and titanium, may be included in addition to the elements listed above.

1. A method of manufacturing a part comprising selective laser melting of a powder comprising a steel alloy containing, by weight, 16% to 19% chromium and 12.2% to 13.5% nickel, wherein the powder is substantially non-magnetic.

2. A method according to claim 1, wherein less than 2% by volume of the steel alloy is in the ferrite phase.

3. A method according to claim 2, wherein less than 1.5% by volume of the steel alloy is in the ferrite phase.

4. A method according to claim 3, wherein less than 1% by volume of the steel alloy is in the ferrite phase.

5. A method according to claim 4, wherein less than 0.5% by volume of the steel alloy is in the ferrite phase.

6. A method according to claim 4, wherein substantially 0% by volume of the steel alloy is in the ferrite phase.

7. A method according to claim 1, wherein the powder has a hall flow of less than 23 s/50 g.

8. A method according to claim 7, wherein the powder has a hall flow of less than 22 s/50 g.

9. A method according to claim 1, wherein the alloy contains, by weight, 12.2% to 13.2% nickel.

10. A method according to claim 9, wherein the alloy contains, by weight, 12.5% to 12.9% nickel.

11. A method according to claim 1, wherein the alloy contains, by weight, less than 1% manganese.

12. A method according to claim 11, wherein the alloy contains, by weight, less than 0.7% manganese.

13. A method according to claim 12, wherein the alloy contains, by weight, less than 0.5% manganese.

14. A method according to claim 11, wherein the alloy contains, by weight, less than 0.01% sulphur.

15. A method according to claim 1, wherein the alloy contains, by weight, 0.05% to 0.4% copper.

16. A method according to claim 1, wherein at least 98% by volume of the alloy is in the austenite phase.

17. A method according to claim 1, wherein the powder has been formed by nitrogen gas atomisation.

18. A method according to claim 1, wherein the powder is atomised from an ingot produced by vacuum arc remelting (VAR).

19. A method according to claim 1, wherein the powder contains at least 90% by weight particles having a size, as measured by a laser diffraction particle size analyser, below 45 μm.

20. A method according to claim 19, wherein the powder contains at least 94% by weight particles having a size, as measured by the laser diffraction particle size analyser, below 45 μm.

21. A method according to claim 20, wherein the powder contains at least 96% by weight particles having a size, as measured by the laser diffraction particle size analyser, below 45 μm.

22. A method according to claim 1, wherein the powder contains less than 2% by weight particles having a size, as measured by a laser diffraction particle size analyser, below 15 μm.

23. A method according to claim 22, wherein the powder contains less than 1% by weight particles having a size, as measured by the laser diffraction particle size analyser, below 15 μm.

24. A powder container arranged to be attached to an additive manufacturing machine, the powder container containing powder comprising a steel alloy containing, by weight, 16% to 19% chromium and 12.2% to 13.5% nickel, wherein the powder is substantially non-magnetic.

25. A method of manufacturing powder for use in additive manufacturing apparatus comprising atomising a molten steel alloy containing, by weight, 16% to 19% chromium and 12.2% to 13.5% nickel such that less than 2% by volume of the steel alloy is in the ferrite phase and filling a container arranged to be attached to an additive manufacturing machine with the powder.

26. A method according to claim 25, comprising nitrogen atomising the molten steel alloy.

27. A method according to claim 25, comprising carrying out vacuum arc remelting (VAR) on the steel alloy before atomisation.
